(19) United States
(12) Patent Application Publication
(10) Pub. No.: US 2017/0105168 A1
(43) Pub. Date: Apr. 13, 2017

(54) TECHNIQUES FOR IDENTIFYING WI-FI DEVICE COLLOCATED WITH A CELLULAR CELL

(71) Applicant: QUALCOMM Incorporated, San Diego, CA (US)

(72) Inventors: Patrick Stupar, Nuremberg (DE); Andrea Garavaglia, Nuremberg (DE); Manu Sharma, San Diego, CA (US); Marc Werner, Heroldsberg (DE)

(21) Appl. No.: 14/878,949

(22) Filed: Oct. 8, 2015

(51) Int. Cl. H04W 48/16; H04W 64/00

(52) U.S. Cl. CPC H04W 48/16; H04W 64/003; H04W 84/042

(57) ABSTRACT

Methods, systems, and devices are described for wireless communication including. A first access point may receive a discovery signal from a second access point. The second access point may be associated with a first radio access technology (RAT). The first access point may determine that the second access point is collocated with a cell of a second RAT based on the received discovery signal. The second RAT may be different from the first RAT.

### BACKGROUND

The following relates generally to wireless communication, and more specifically to identifying a Wi-Fi device collocated with a cellular cell.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., IEEE 802.11) network may include an AP that may communicate with stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

In some embodiments, multiple base stations densely deployed in a small geographic area may create interference issues. In such cases, a wireless device may have difficulty discovering neighboring cells, especially if the base stations are Long Term Evolution (LTE) base stations such as an Evolved UMTS Terrestrial Radio Access Network Node Bs (eNB), which may have weaker signals. In current deployments, a wireless device may use existing LTE discovery procedures, such as Automatic Neighbor Relation (ANR) detection, to discover neighboring base stations; however, the current LTE discovery procedures may not be sufficient for wireless devices to discover neighboring cells.

### SUMMARY

Wireless fidelity (Wi-Fi) networks may operate with little to no interference, thus enabling Wi-Fi base stations (i.e., access points (AP)) to potentially detect neighboring base stations not visible to an Long Term Evolution (LTE) base station (i.e., eNB) in a dense environment. A reference AP may perform Wi-Fi measurements (e.g., received signal to noise indicator (RSNI); received channel power indicators (RCPI), path loss estimates, channel load, noise histogram, etc.) to discover neighboring base stations; however, in some embodiments, discovering a neighboring AP does not necessarily indicate an LTE Neighboring Small Cell (NSC) is collocated with the neighboring AP.

In one embodiment, within a centralized database (e.g., an operations, administration, and management (OAM) database and/or other generic centralized server) a mapping between AP media access control (MAC) addresses and Evolved Universal Terrestrial Access Network (E-UTRAN) Cell Global Identifier (ECGI) of collocated LTE cells is maintained. At the time of powering up, a small cell provides to the operations, administration, and management (OAM)/generic server the MAC address of a collocated AP, as well as the ECGI of the small cell. The reference AP can retrieve database information to determine which of the APs is collocated with a small cell. If there is data to be retrieved, the reference AP becomes aware of a small cell collocated with the AP. If there are no corresponding LTE cells, the data indicates a stand-alone AP.

The server then propagates the information within the neighborhood of small cells. In one example embodiment, the information can be distributed and/or requested by the eNB receiving an unknown Wi-Fi AP address. If the server is unable to provide corresponding ECGI information, the server can poll other servers which may occur if neighbor small cells use different OAM servers.

In another embodiment, frames of the ECGI containing the collocated small cell are inserted into the beacons and probe responses. In one example, the ECGI may be vendor specific content. In another example, the ECGI may be a standard information element (IE). The Wi-Fi measurements enable the beacon request/response to indicate which information should be collected.

In yet another embodiment, a generic advertisement service (GAS) provides functionality which enables mobile stations (STAs) to discover the availability of information related to desired network services, where the network services may include neighboring small cell (NSC) availability. The reference AP within the small cell may transmit a GAS ECGI query to a collocated AP within the NSC, from which a response can be sent back to the reference AP. In this embodiment, the GAS elements are IEs used to exchange network services information with GAS protocol.

A method of wireless communication is described. The method may include receiving, at a first access point, a discovery signal from a second access point, the second access point associated with a first radio access technology (RAT), and determining, by the first access point, that the second access point is collocated with a cell of a second RAT based at least in part on the received discovery signal, the second RAT being different from the first RAT.

An apparatus for wireless communication is described. The apparatus may include a polling component to receive a discovery signal from a first access point, the first access point associated with a first RAT and a mapping component to determine that the first access point is collocated with a cell of a second RAT based at least in part on the received discovery signal, the second RAT being different from the first RAT.

A further apparatus is described. The apparatus may include a processor, memory in electronic communication with the processor, and instructions stored in the memory. The instructions may be operable to cause the processor to receive a discovery signal from a first access point, the first access point associated with a first RAT and determine that the first access point is collocated with a cell of a second RAT based at least in part on the received discovery signal, the second RAT being different from the first RAT.

A non-transitory computer readable medium for wireless communication is described. The non-transitory computer-readable medium may include instructions to cause a processor to receive, at a first access point, a discovery signal from a second access point, the second access point associated with a first radio access technology (RAT), and determine, by the first access point, that the second access point is collocated with a cell of a second RAT based at least in part on the received discovery signal, the second RAT being different from the first RAT.

In some examples of the method, apparatuses, and/or non-transitory computer-readable medium described herein may further include retrieving information from a centralized database, the retrieved information comprising a mapping between at least a first unique identifier associated with the second access point and a second unique identifier associated with the cell of the second RAT.

Some examples of the method, apparatuses, and/or non-transitory computer-readable described herein may further include processes, features, means or instructions for transmitting the retrieved information to at least one neighboring cell of the second RAT.

In some examples of the method, apparatus, or non-transitory computer-readable medium described herein, the first unique identifier is a media access control (MAC) address, and the second unique identifier is a ECGI.

Some examples of the method, apparatuses, and/or non-transitory computer-readable medium described herein may further include processes, features, means or instructions for identifying an information element inserted in the beacon, the information element indicating a presence of the cell of the second RAT.

In some examples of the method, apparatus, or non-transitory computer-readable medium described herein, the information element is associated with a wireless communication operator. In some examples of the method, apparatus, or non-transitory computer-readable medium described above, the information element may be a ECGI associated with the cell of the second RAT. In other examples, the information element may contain an advertisement element. In other examples, the information element may contain an access network query protocol (ANQP) element.

Some examples of the method, apparatuses, and/or non-transitory computer-readable medium described herein may further include processes, features, means or instructions for transmitting, to the second access point, a query by way of an advertisement protocol; and receiving, from the second access point, an information element associated with the second access point, the information element received by way of the advertisement protocol.

In some examples of the method, apparatuses, and/or non-transitory computer-readable medium described herein, the first RAT comprises a wireless local area network (WLAN) and the second RAT comprises a cellular network.

In some examples of the method, apparatuses, and/or non-transitory computer-readable medium described here the discovery signal may further include a beacon insertion component to identify an information element inserted in the beacon, the information element indicating a presence of the cell of the second RAT.

### BRIEF DESCRIPTION OF THE DRAWINGS

A further understanding of the nature and advantages of the present disclosure may be realized by reference to the following drawings. In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of a wireless communication system in accordance with various aspects of the present disclosure;

FIG. 2 shows a message flow diagram illustrating a flow of communications between various devices, in accordance with various aspects of the present disclosure;

FIG. 3 shows a message flow diagram illustrating a flow of communications between various devices, in accordance with various aspects of the present disclosure;

FIG. 4 shows a message flow diagram illustrating a flow of communications between various devices, in accordance with various aspects of the present disclosure;

FIG. 5 shows a block diagram illustrating an example of a wireless communication device, in accordance with various aspects of the present disclosure;

FIG. 6 shows a block diagram illustrating an example of a wireless communication device, in accordance with various aspects of the present disclosure;

FIG. 7 shows a block diagram of a system in accordance with various aspects of the present disclosure; and

FIG. 8 shows a flow chart illustrating an example of a method for wireless communication, in accordance with various aspects of the present disclosure;

FIG. 9 shows a flow chart illustrating another example of a method for wireless communication, in accordance with various aspects of the present disclosure;

FIG. 10 shows a flow chart illustrating another example of a method for wireless communication, in accordance with various aspects of the present disclosure; and

FIG. 11 shows a flow chart illustrating another example of a method for wireless communication, in accordance with various aspects of the present disclosure.

### DETAILED DESCRIPTION

The present disclosure relates to improved systems, methods, and/or apparatuses for identifying a wireless fidelity (Wi-Fi) device collocated with a cellular cell (e.g., a Long Term Evolution (LTE) small cell). In particular, the present disclosure is directed to enabling an access point (AP) to discover a neighboring Wi-Fi collocated within an LTE cell using, at least, Wi-Fi data and measurements.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

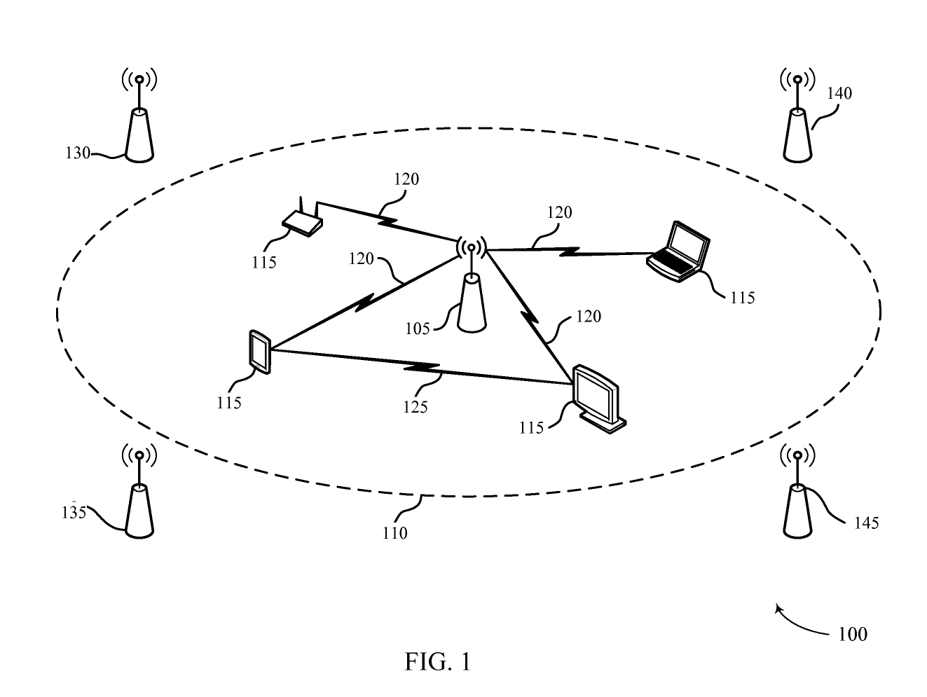

FIG. 1 illustrates a wireless local area network (WLAN) 100 (also known as a Wi-Fi network) configured in accordance with various aspects of the present disclosure. The WLAN 100 may include a base station 105 and multiple associated devices and/or mobile stations (STAs) 115, which may represent devices such as personal digital assistant (PDAs), other handheld devices, netbooks, notebook computers, tablet computers, laptops, display devices (e.g., TVs, computer monitors, etc.), printers, etc.

The base station 105 may be a Wireless Fidelity (Wi-Fi) access point (AP). AP 105 may communicate with STAs 115 over wireless communication links 120 using a plurality of radio access technologies (RATs). The AP 105 and the associated stations 115 may represent a Basic Set Service (BSS) and/or an Extended Set Service (ESS). In one embodiment, the various STAs 115 in the network are able to communicate with one another through the AP 105. Also shown is a coverage area 110 of the AP 105, which may represent a Basic Service Area (BSA) of the WLAN 100. An extended network station associated with the WLAN 100 may be connected to a wired and/or wireless distribution system (DS) that may allow multiple APs 105 to be connected in an ESS.

A STA 115 may be located in the intersection of more than one coverage area 110 and may associate with more than one AP 105. A single AP 105 and an associated set of STAs 115 may be referred to as a BSS. An ESS can be a set of connected BSSs. A distribution system (DS) (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and media access control (MAC) layers from IEEE 802.11 and versions including, but not limited to, 802.11b, 802.11g, 802.11a, 802.11n, 802.11ac, 802.11ad, 802.11ah, etc. In other implementations, peer-to-peer connections and/or ad hoc networks may be implemented within WLAN 100.

In one embodiment, AP 105 may be a Wi-Fi access point collocated with an LTE E-UTRAN Node B (eNodeB and/or eNB). In this embodiment, and with reference to later discussions within this description, AP 105 may be considered the “reference AP.” Reference AP 105 may be deployed in an area having more than one neighboring AP; for example, multiple APs may be neighboring small cells (NSC) deployed densely in a small area such as a residential home and/or a small business (e.g., coffee shop, doctor office, etc.). In one embodiment, an NSC may be a picocell and/or a femtocell, but in other embodiments the NSC may have a smaller and/or larger coverage area.

In FIG. 1, base stations 130, 135, 140, and/or 145 may each by an example of a standalone Wi-Fi AP, a standalone LTE NSC (e.g, eNB), or may be a Wi-Fi AP collocated with an LTE NSC. If the APs 130, 135, 140, and 145 are deployed in a dense geographic area, there may be interference which makes it difficult for a STA 115 to detect NSCs with a weaker transmission. For example, APs 130 and 135 may be discoverable by a STA 115 communicating with reference AP 105 by way of LTE discovery procedures (e.g. self-organizing network (SON) technology such as Automatic Neighbor Relation (ANR) detection). However, APs 140 and 145 may not be discoverable by the STA 115 through LTE discovery procedures alone.

As a result, an AP may utilize Wi-Fi technologies. In some embodiments, Wi-Fi measurements may be used to detect otherwise non-discoverable APs, such as APs 140 and 145. In additional embodiments, AP 105 may discover neighboring APs 130, 135, 140, and/or 145; however, there may be no indication that each of the neighboring APs is collocated with an NSC. Thus, the following description provides potential solution for a reference AP not only determining the existence of a neighbor AP, but also that the neighbor AP is collocated with an NSC.

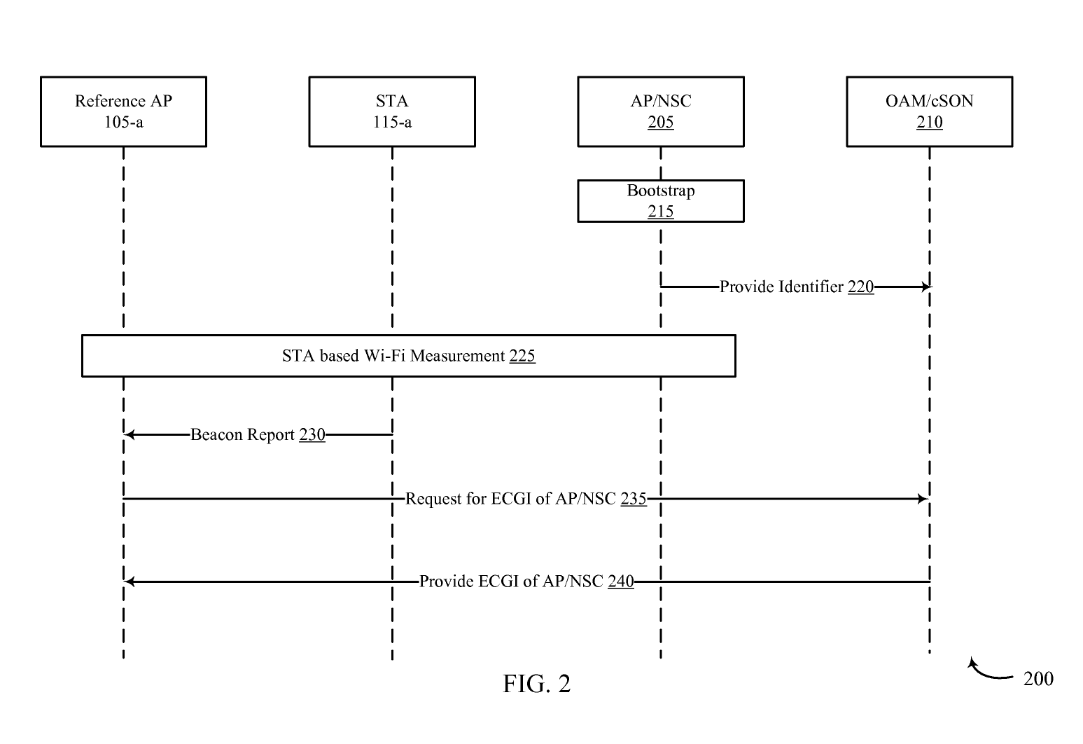

FIG. 2 shows a message flow diagram 200 illustrating a flow of communications between various devices, in accordance with various aspects of the present disclosure. Diagram 200 illustrates communication between an example reference AP 105-a, a STA 115-a a second AP collocated with an NSC 205 and a centralized database stored on a remote server 210 (e.g., an operations, administration, and management (OAM) server and/or a centralized self-organizing network (cSON) server). Reference AP 105-a and STA 115-a may be examples of reference AP 105 and STA 115 described with reference to FIG. 1, respectively. AP/NSC 205 may be an example of any of the base stations 130, 135, 140, and/or 145 described with reference to FIG. 1.

In one embodiment, the AP/NSC 205 is powered on and begins a bootstrap procedure 215. In step 220, the NSC communicates with remote server 210. More specifically, the AP/NSC 205 communicates a unique identifier associated with the AP portion of the collocated AP/NSC 205. In addition, the NSC sends a unique identifier associated with the NSC portion of the AP/NSC 205. In one embodiment, the AP unique identifier can be a media access control address (MAC address), and the NSC unique identifier can be an enhanced cell global identifier (ECGI). The centralized database then maintains a mapping of each AP collocated with an NSC based on receipt of the MAC address and ECGI received from AP/NSC 205.

After at least one mapping between an AP and a collocated NSC is stored in the database, remote server 210 propagates the mapped identifiers to other NSCs within the neighborhood. STA-based Wi-Fi measurements 225, such as RCPI or RSNI, may enable the beacon report 230 sent to the reference AP 105-b to indicate which information element needs to be collected with respect to which collocated base station.

In one example embodiment, such as if other NSCs communicate with a different remote serve than remote server 210, the mapped data can be distributed and/or requested by the eNB receiving an unknown AP MAC address, as shown in step 235. If the remote server 210 is unable to provide corresponding ECGI information, the server can poll other servers which may occur if neighbor small cells use different OAM servers. In step 240, if the remote server 210 is able to provide corresponding ECGI information, the server will provide the information to the reference AP 105-a.

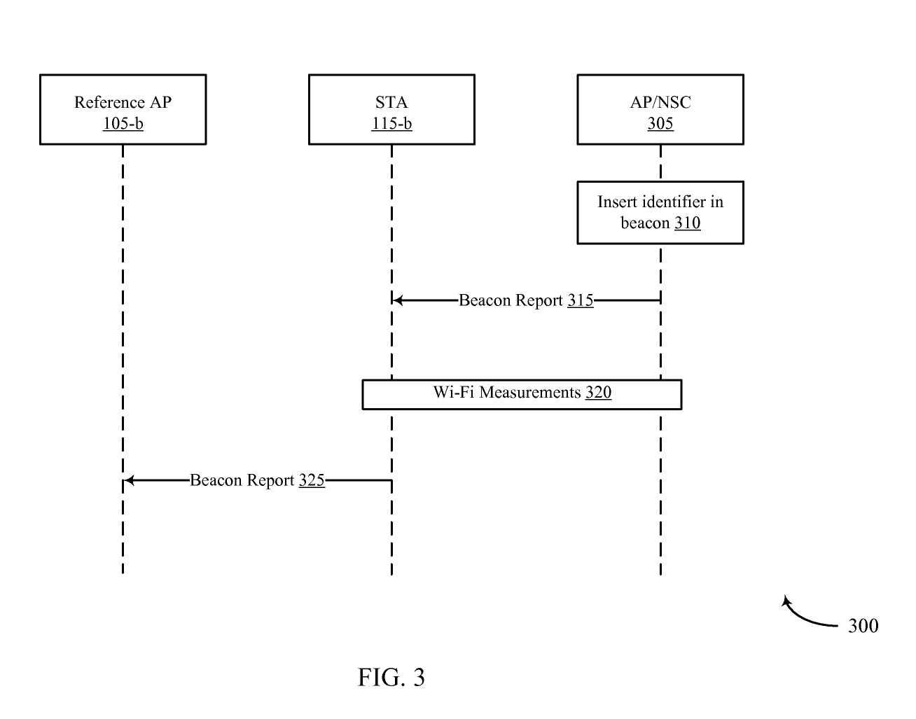

FIG. 3 shows a message flow diagram 300 illustrating a flow of communications between various devices, in accordance with various aspects of the present disclosure. Diagram 300 illustrates communication between an example reference AP 105-b, a STA 115-b, a second AP collocated with an NSC 305 (referred to herein as AP/NSC 305). Reference AP 105-b and STA 115-b may be examples of reference AP 105 and STA 115 described with reference to FIG. 1, respectively. AP/NSC 305 may be an example of any of the base stations 130, 135, 140, and/or 145 described with reference to FIG. 1.

In step 310, the ECGI of the NSC portion of the collocated AP/NSC 305 is inserted in a beacon management frame. In one embodiment, the ECGI may be vendor specific; however, in another embodiment, the inserted ECGI may be a standard information element (IE). Wi-Fi measurements 320 enable the beacon report 325 to indicate which information element needs to be collected. For example, if AP/NSC 305 inserts the ECGI of the collocated NSC, STA 115-b can collect the information and send the collocation information to the reference AP 105-b in a beacon report 325. If there is no assistance offered by the STA 115-b and a beacon report can be sent directly from AP/NSC 305 to the reference AP 105-b.

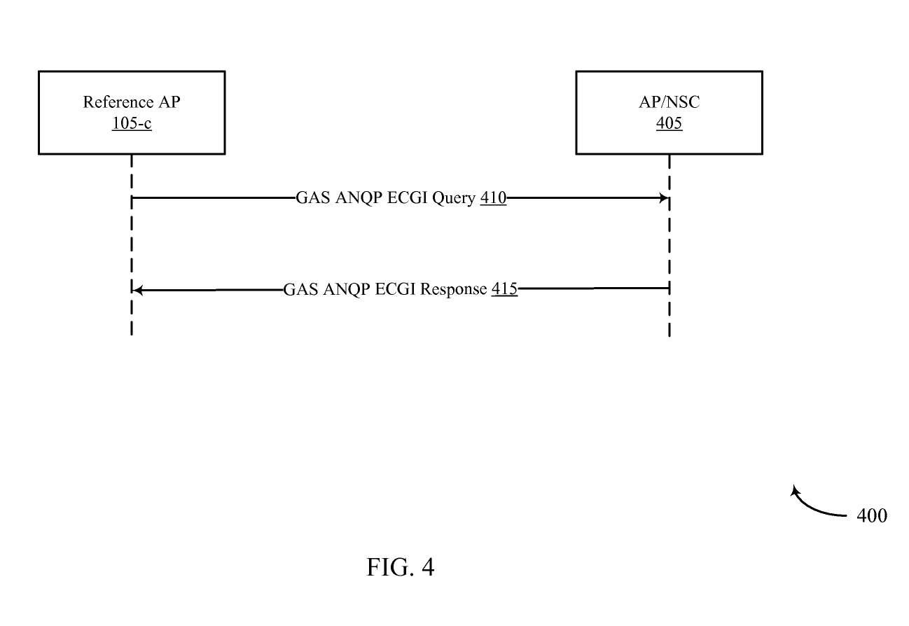

FIG. 4 shows a message flow diagram 400 illustrating a flow of communications between various devices, in accordance with various aspects of the present disclosure. Diagram 400 illustrates communication between an example reference AP 105-c, and a second AP collocated with an NSC 405 (referred to herein as AP/NSC 405). Reference AP 105-b may be an example of reference AP 105 described with reference to FIG. 1. AP/NSC 405 may be an example of any of the base stations 130, 135, 140, and/or 145 described with reference to FIG. 1.

In one embodiment, the reference AP 105-c may transmit an advertisement protocol ECGI query 410 to the AP collocated with NSC in AP/NSC 405, where the advertisement protocol is a query and response protocol that defines services offered by an AP such as Access Network Query Protocol (ANQP). Subsequently, an advertisement protocol ECGI response 415 can be sent from AP/NSC 405 back to reference AP 105-c. In this embodiment, the advertisement protocol elements sent between reference AP 105-c and AP/NSC may be information elements sent to exchange network services information with GAS protocol. Communication via a GAS protocol may thus enable reference AP 105-c and AP/NSC 405 to exchange identifier IEs which are used to identify an NSC collocated with an AP.

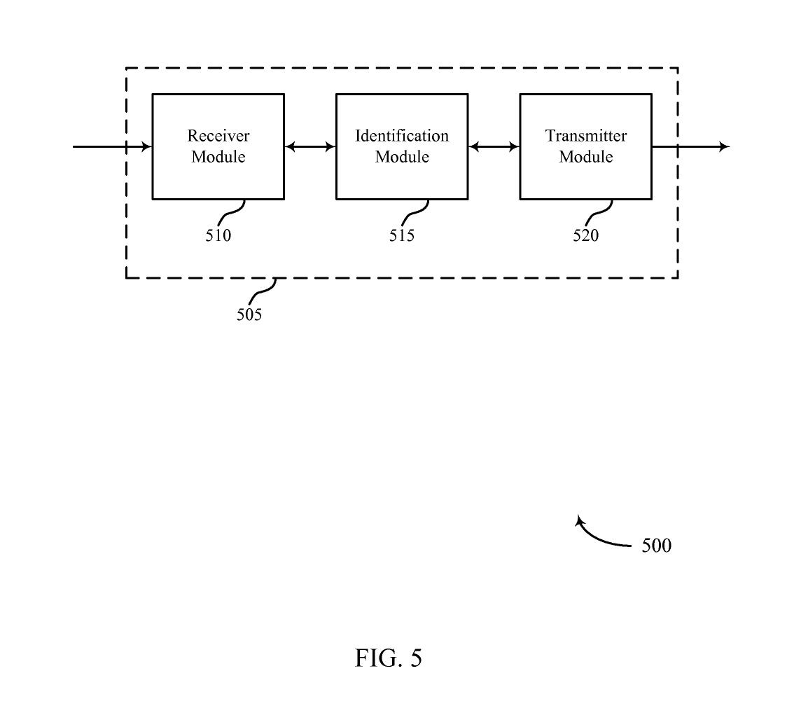

FIG. 5 shows a block diagram 500 illustrating an example of a wireless communication device 505 for use in wireless communication in accordance with various aspects of the present description. The device 505 may be an example of at least one of the base stations in FIG. 1, such as reference AP 105. The device 505 may include a receiver module 510, an identification module 515, and/or a transmitter module 520. The device 505 may also be or include a processor. Each of these modules may be in communication with one another.

The device 505, through the receiver module 510, the identification module 515, and/or the transmitter module 520, may perform functions described herein. For example, the device 505 may detect the existence of a neighboring AP collocated with an LTE NSC.

The components of the device 505 (as well as those of other related devices described herein) may, individually or collectively, be implemented using application-specific integrated circuits (ASICs) adapted to perform some or all of the applicable functions in hardware. Alternatively, the functions may be performed by other processing units (or cores), on integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by general and/or application-specific processors.

The receiver module 510 may receive information such as packets, user data, and/or control information associated with various information channels (e.g., control channels, data channels, etc.). The receiver module 510 may receive requests regarding identification, detection, and association of Wi-Fi APs collocated with LTE NSCs. Information may be passed on to the identification module 515, and to other components of the device 505.

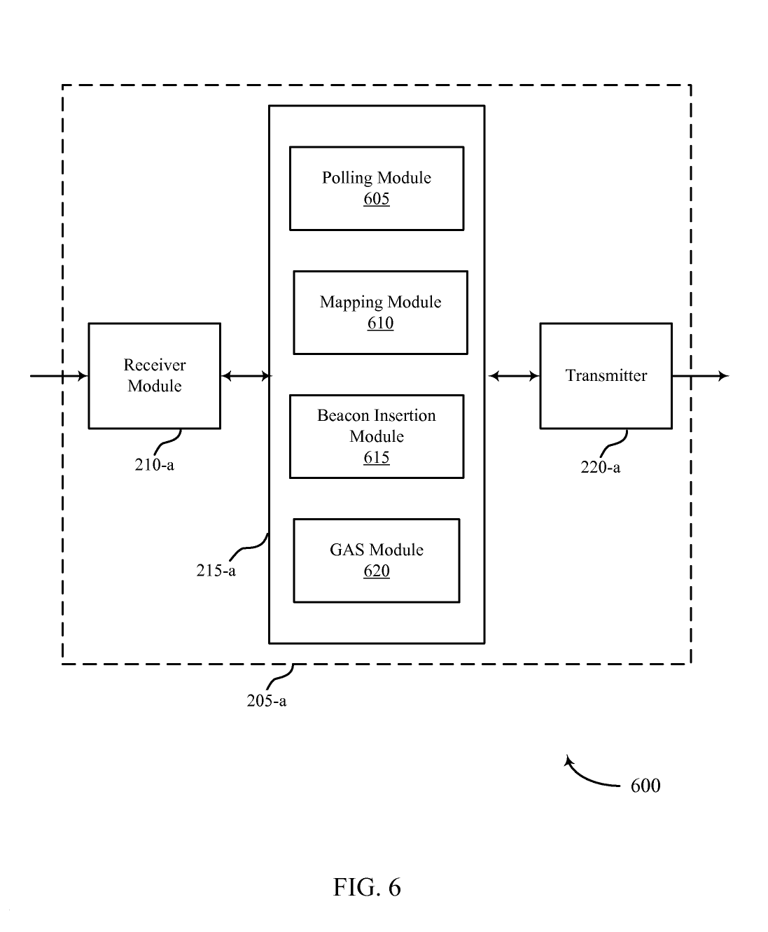

The identification module 515 may receive Wi-Fi measurements to assist LTE self-organizing network (SON) technologies in locating neighboring AP cells collocated with LTE NSCs. More details regarding the enablement of identification module 515 are described with reference to FIG. 6.

The transmitter module 520 may transmit information regarding the discovery of LTE NSCs. In some examples, the transmitter module 520 may be collocated with the receiver module 510 in a transceiver component. The transmitter module 520 may include a single antenna, or it may include a plurality of antennas.

FIG. 6 shows a block diagram illustrating an example of a wireless communication device, in accordance with various aspects of the present disclosure. The device 600 may be an example of at least one aspect of device 505 referred to with respect to FIG. 5. The device 600 may include a receiver module 510-a, an identification module 515-a, and/or a transmitter module 520-a, which may be examples of the corresponding components of device 505 from FIG. 5. The device 505-a may also be or include a processor. Each of these components may be in communication with each other.

The identification module 515-a may include a polling module 605, a mapping module 610, a beacon insertion module 615, and a GAS module 620. The receiver module 510-a and the transmitter module 520-a may perform the functions of the receiver module 510 and the transmitter module 520, of FIG. 5, respectively.

In one embodiment, polling module 605 may perform at least some of the communications and methods described with reference to FIG. 2. Mapping module 610 may create and maintain a mapping of the unique identifiers as described with reference to FIG. 2. beacon insertion module 615 may be enabled to perform at least some of the communications and methods described with reference to FIG. 3. GAS module 620 may be enabled to perform at least some of the communications and methods described with reference to FIG. 4.

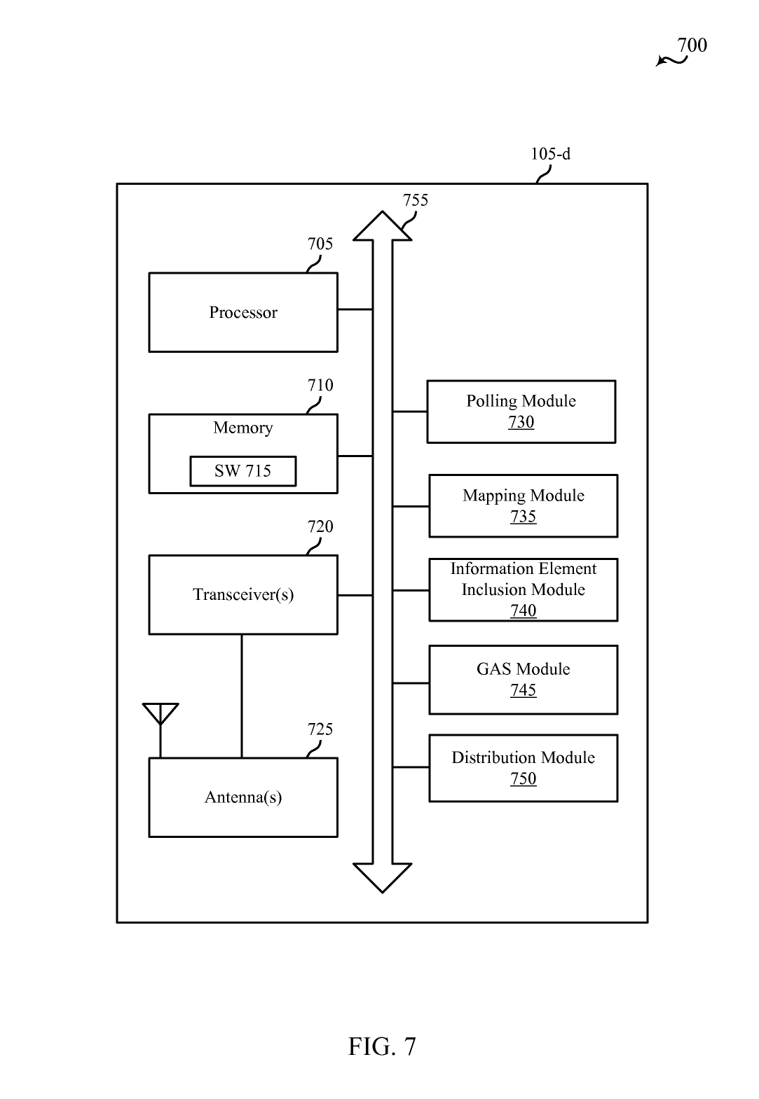

FIG. 7 shows a block diagram 700 of an example AP 105-d in accordance with various aspects of the present disclosure. AP 105-d may be an example of reference AP 105 described with reference to FIG. 1. The AP 105-d includes a processor 705, a memory 710, at least one transceiver 720, at least one antenna 725, polling module 730, mapping module 735, information element inclusion module 740, GAS module 745, and distribution module 750. The processor 705, memory 710, transceiver(s) 720, polling module 730, mapping module 735, information element inclusion module 740, GAS module 745, and distribution module 750 are communicatively coupled with a bus 755, which enables communication between these components. The antenna(s) 725 are communicatively coupled with the transceiver(s) 720.

The processor 705 can be an intelligent hardware device, such as a central processing unit (CPU), a microcontroller, an application-specific integrated circuit (ASIC), etc. The processor 705 processes information received through the transceiver(s) 720 and information to be sent to the transceiver(s) 720 for transmission through the antenna(s) 725.

The memory 710 stores computer-readable, computer-executable software (SW) code 715 containing instructions that, when executed, cause the processor 705 or another one of the components of the AP 105-b to perform various functions described herein, for example, performing timing management functions associated with ranging over multiple antennas.

The transceiver(s) 720 communicate bi-directionally with other wireless devices, such as APs 105, 130, 135, 140, 145, and/or STAs 115, as well as other devices. The transceiver(s) 720 may include a modem to modulate packets and frames and provide the modulated packets to the antenna(s) 725 for transmission. The modem can be additionally used to demodulate packets received from the antenna(s) 725.

The polling module 730, mapping module 735, information element inclusion module 740, GAS module 745 implement the features described with reference to FIGS. 1-6. The distribution module 750 may be enabled to distribute collocation information to a plurality of neighborhood APs and NSCs.

It is to be understood that FIG. 7 illustrates only one possible implementation of a device executing the features of FIGS. 1-6. While the components of FIG. 7 are shown as discrete hardware blocks (e.g., ASICs, field programmable gate arrays (FPGAs), semi-custom integrated circuits, etc.) for purposes of clarity, it will be understood that each of the components may also be implemented by multiple hardware blocks adapted to execute some or all of the applicable features in hardware. Alternatively, features of two or more of the components of FIG. 7 may be implemented by a single, consolidated hardware block. For example, a single transceiver 720 chip may implement the processor 705, memory 710, polling module 730, mapping module 735, information element inclusion module 740, GAS module 745, and distribution module 750.

In still other examples, the features of each component may also be implemented, in whole or in part, with instructions embodied in a memory, formatted to be executed by general or application-specific processors.

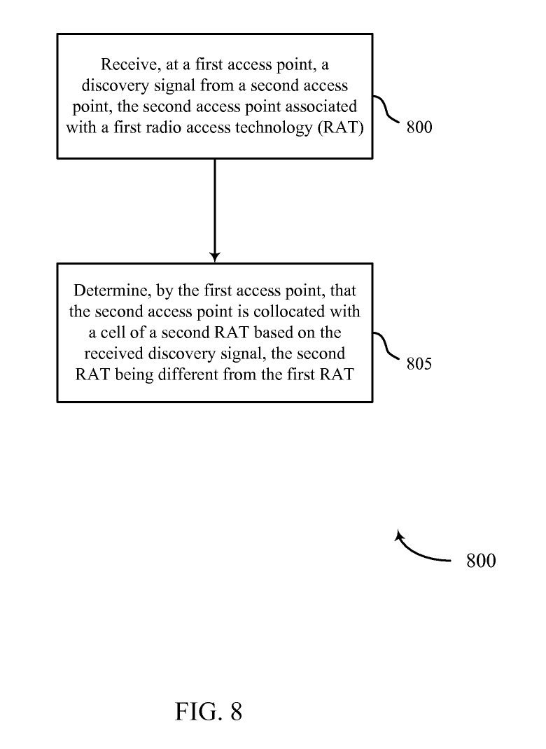

FIG. 8 shows a flowchart illustrating a method 800 for identifying a cellular cell collocated with a Wi-Fi device in accordance with various aspects of the present disclosure. The operations of method 800 may be implemented by an AP 105 and/or its components as described with reference to FIGS. 1-7. For example, the operations of method 800 may be performed by the identification module 515 as described with reference to FIG. 5. In some examples, an AP 105 may execute a set of codes to control the functional elements of the AP 105 to perform the functions described below. Additionally or alternatively, the AP 105 may perform aspects the functions described below using special-purpose hardware.

At block 805, the AP 105 may receive a discovery signal from a second access point, the second access point associated with a first radio access technology (RAT) as described with reference to FIGS. 1-7. In certain examples, the operations of block 805 may be performed by the identification module 515 as described with reference to FIG. 5.

At block 810, the AP 105 may determine that the second access point is collocated with a cell of a second RAT based at least in part on the received discovery signal, the second RAT being different from the first RAT as described with reference to FIGS. 1-7. In certain examples, the operations of block 810 may be performed by the identification module 515 as described with reference to FIG. 5.

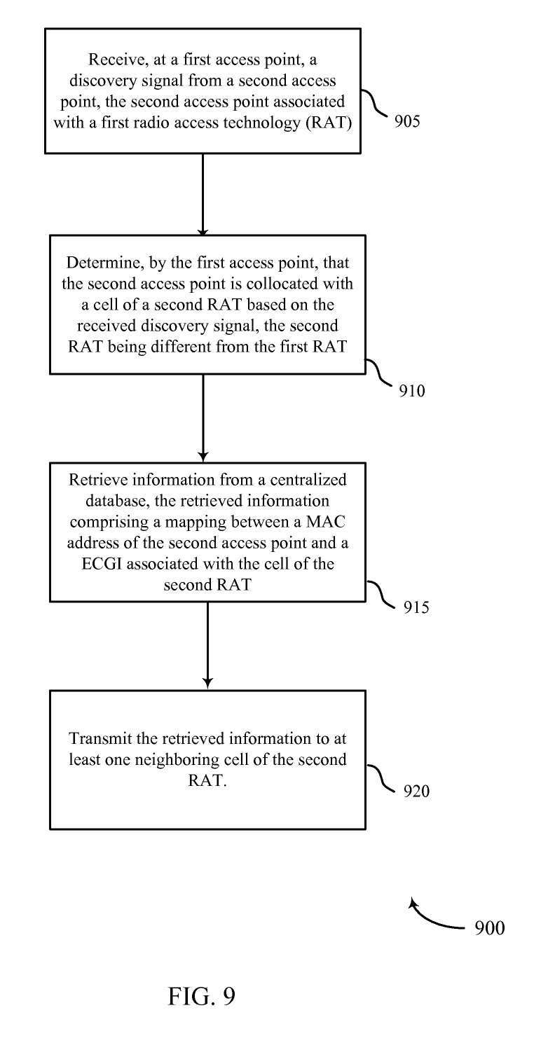

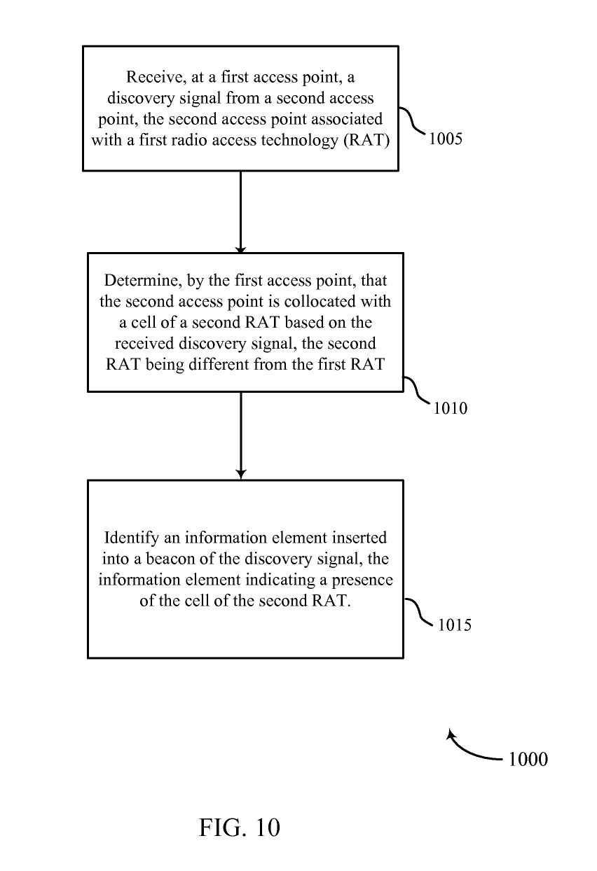

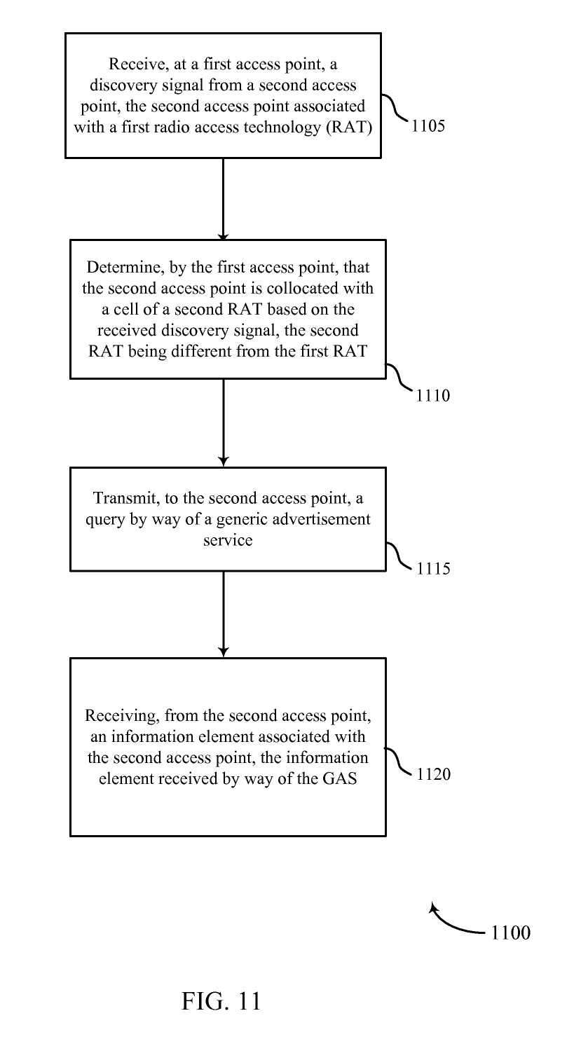

FIG. 9 shows a flow chart illustrating another example of a method 900 for wireless communication, in accordance with various aspects of the present disclosure. The operations of method 900 may be implemented by an AP 105 and/or its components as described with reference to FIGS. 1-8. For example, the operations of method 900 may be performed by the identification module 515 as described with reference to FIG. 5. In some examples, an AP 105 may execute a set of codes to control the functional elements of the AP 105 to perform the functions described below. Additionally or alternatively, the AP 105 may perform aspects the functions described below using special-purpose hardware. The method 900 may also incorporate aspects of method 800 of FIG. 8 and methods 1000 and 1100 of FIGS. 10-11 described below.

At block 905, the AP 105 may receive a discovery signal from a second access point, the second access point associated with a first radio access technology (RAT) as described with reference to FIGS. 1-8. In certain examples, the operations of block 905 may be performed by the identification module 515 as described with reference to FIG. 5.

At block 910, the AP 105 may determine that the second access point is collocated with a cell of a second RAT based at least in part on the received discovery signal, the second RAT being different from the first RAT as described with reference to FIGS. 1-8. In certain examples, the operations of block 910 may be performed by the identification module 515 as described with reference to FIG. 5.

At block 915, the AP 105 may retrieve information from a centralized database, the retrieved information comprising a mapping between a MAC address of the second access point and an ECGI associated with the cell of the second RAT as described with reference to FIGS. 1-8. In certain examples, the operations of block 915 may be performed by the mapping module 610 as described with reference to FIG. 6.

At block 920, the AP 105 may transmit the retrieved information to at least one neighboring cell of the second RAT as described with reference to FIGS. 1-8. In certain examples, the operations of block 920 may be performed by the transmitter module 520 as described with reference to FIG. 5.

FIG. 10 shows a flowchart illustrating a method 1000 for identifying a cellular cell collocated with a Wi-Fi device in accordance with various aspects of the present disclosure. The operations of method 1000 may be implemented by an AP 105 and/or its components as described with reference to FIGS. 1-9. For example, the operations of method 1000 may be performed by the identification module 515 as described with reference to FIG. 5. In some examples, an AP 105 may execute a set of codes to control the functional elements of the AP 105 to perform the functions described below. Additionally or alternatively, the AP 105 may perform aspects the functions described below using special-purpose hardware. The method 1000 may also incorporate aspects of methods 800 and 900 of FIGS. 8-9 and/or aspects of method 1100 described with respect to FIG. 11.

At block 1005, the AP 105 may receive a discovery signal from a second access point, the second access point associated with a first radio access technology (RAT) as described with reference to FIGS. 1-9. In certain examples, the operations of block 1005 may be performed by the identification module 515 as described with reference to FIG. 5.

At block 1010, the AP 105 may determine that the second access point is collocated with a cell of a second RAT based at least in part on the received discovery signal, the second RAT being different from the first RAT as described with reference to FIGS. 1-9. In certain examples, the operations of block 1010 may be performed by the identification module 515 as described with reference to FIG. 5.

At block 1015, the AP 105 may identify an information element inserted into a beacon of the discovery signal, the information element indicating a presence of the cell of the second RAT. In certain examples, the operations of block 1010 may be performed by the beacon insertion module 615 as described with reference to FIG. 6.

FIG. 11 shows a flowchart illustrating a method 1100 for identifying a cellular cell collocated with a Wi-Fi device in accordance with various aspects of the present disclosure. The operations of method 1100 may be implemented by an AP 105 and/or its components as described with reference to FIGS. 1-10. For example, the operations of method 1100 may be performed by the Identification Module 515 as described with reference to FIG. 5. In some examples, an AP 105 may execute a set of codes to control the functional elements of the AP 105 to perform the functions described below. Additionally or alternatively, the AP 105 may perform aspects the functions described below using special-purpose hardware. The method 1100 may also incorporate aspects of methods 800, 900, and/or 1000 of FIGS. 8-10.

At block 1105, the AP 105 may receive a discovery signal from a second access point, the second access point associated with a first radio access technology (RAT) as described with reference to FIGS. 1-10. In certain examples, the operations of block 1105 may be performed by the identification module 515 as described with reference to FIG. 5.

At block 1110, the AP 105 may determine that the second access point is collocated with a cell of a second RAT based at least in part on the received discovery signal, the second RAT being different from the first RAT as described with reference to FIGS. 1-10. In certain examples, the operations of block 1110 may be performed by identification module 515 as described with reference to FIG. 5.

At block 1115, the AP 105 may transmit, to the second access point, a query by way of a generic advertisement service. In certain examples, the operations of block 1115 may be performed by GAS module 620 as described with reference to FIG. 6 and/or by transmitter module 520 as described with reference to FIG. 5.

At block 1120, the AP 105 may receive from the second access point, an information element associated with the second access point, the information element received by way of the GAS. In certain examples, the operations of block 1115 may be performed by GAS module 620 as described with reference to FIG. 6 and/or by transmitter module 520 as described with reference to FIG. 5.

Thus, methods 800-1100, may provide for identifying a cellular cell collocated with a Wi-Fi device. It should be noted that methods 800-1100 describe possible implementation, and that the operations and the steps may be rearranged or otherwise modified such that other implementations are possible. In some examples, aspects from two or more of the methods 800-1100 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

In the appended figures, similar components and/or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection can be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method of wireless communication, comprising:
receiving, at a first access point, a discovery signal from a second access point, the second access point associated with a first radio access technology (RAT); and
determining, by the first access point, that the second access point is collocated with a cell of a second RAT based at least in part on the received discovery signal, the second RAT being different from the first RAT.

2. The method of claim 1, wherein the determining further comprises:
retrieving information from a centralized database, the retrieved information comprising a mapping between at least a first unique identifier associated with the second access point and a second unique identifier associated with the cell of the second RAT.

3. The method of claim 2, further comprising:
transmitting the retrieved information to at least one neighboring cell of the second RAT.

4. The method of claim 2, wherein the first unique identifier is a media access control (MAC) address.

5. The method of claim 2, wherein the second unique identifier is an Evolved Universal Terrestrial Access Network (E-UTRAN) Cell Global Identifier (ECGI).

6. The method of claim 1, wherein the discovery signal comprises a beacon, the determining further comprises:
identifying an information element inserted in the beacon, the information element indicating a presence of the cell of the second RAT.

7. The method of claim 6, wherein the information element is associated with a wireless communication operator.

8. The method of claim 6, wherein the information element comprises an Evolved Universal Terrestrial Access Network (E-UTRAN) Cell Global Identifier (ECGI) associated with the cell of the second RAT.

9. The method of claim 1, wherein the determining further comprises:
transmitting, to the second access point, a query by way of an advertisement protocol; and
the method further comprising receiving, from the second access point, an information element associated with the second access point, the information element received by way of the advertisement protocol.

10. The method of claim 9, wherein the information element comprises an access network query protocol (ANQP) element.

11. The method of claim 1, wherein the first RAT comprises a wireless local area network (WLAN) and the second RAT comprises a cellular network.

12. An apparatus for wireless communication, comprising:
a polling component to receive a discovery signal from a first access point, the first access point associated with a first radio access technology (RAT); and
a mapping component to determine that the first access point is collocated with a cell of a second RAT based at least in part on the received discovery signal, the second RAT being different from the first RAT.

13. The apparatus of claim 12, wherein the mapping component further retrieves information from a centralized database, the retrieved information comprising a mapping between at least a first unique identifier associated with the first access point and a second unique identifier associated with the cell of the second RAT.

14. The apparatus of claim 13, further comprising:
a transmitter to transmit the retrieved information to at least one neighboring cell of the second RAT.

15. The apparatus of claim 13, wherein the first unique identifier is a media access control (MAC) address.

16. The apparatus of claim 13, wherein the second unique identifier is an Evolved Universal Terrestrial Access Network (E-UTRAN) Cell Global Identifier (ECGI).

17. The apparatus of claim 12, wherein the discovery signal comprises a beacon, the apparatus further comprising:
a beacon insertion component to identify an information element inserted in the beacon, the information element indicating a presence of the cell of the second RAT.

18. The apparatus of claim 12, further comprises:
a transmitter to transmit, to the first access point, a query by way of an advertisement protocol; and
the apparatus further comprising an advertisement protocol component to receive, from the first access point, an information element associated with the first access point, the information element received by way of the advertisement protocol.

19. An apparatus for wireless communication, comprising:
a processor;
memory in electronic communication with the processor; and
instructions stored in the memory and operable, when executed by the processor, to cause the apparatus to:
receive a discovery signal from a first access point, the first access point associated with a first radio access technology (RAT); and
determine that the first access point is collocated with a cell of a second RAT based at least in part on the received discovery signal, the second RAT being different from the first RAT.

20. The apparatus of claim 19, wherein the instructions are operable to cause the apparatus to:
retrieve information from a centralized database, the retrieved information comprising a mapping between at least a first unique identifier associated with the first access point and a second unique identifier associated with the cell of the second RAT.

21. The apparatus of claim 20, wherein the instructions are operable to cause the apparatus to:
transmit the retrieved information to at least one neighboring cell of the second RAT.

22. The apparatus of claim 20, wherein the first unique identifier is a media access control (MAC) address.

23. The apparatus of claim 20, wherein the second unique identifier is an Evolved Universal Terrestrial Access Network (E-UTRAN) Cell Global Identifier (ECGI).

24. The apparatus of claim 19, wherein the discovery signal comprises a beacon, the instructions being operable to cause the apparatus to:
identify an information element inserted in the beacon, the information element indicating a presence of the cell of the second RAT.

25. The apparatus of claim 24, wherein the information element is associated with a wireless communication operator.

26. The apparatus of claim 24, wherein the information element comprises an Evolved Universal Terrestrial Access Network (E-UTRAN) Cell Global Identifier (ECGI) associated with the cell of the second RAT.

27. The apparatus of claim 19, wherein the instructions are operable to cause the apparatus to:
transmit, to the first access point, a query by way of an advertisement protocol; and
wherein the instructions are operable to cause the apparatus to receive, from the first access point, an information element associated with the first access point, the information element received by way of the advertisement protocol.

28. The apparatus of claim 27, wherein the information element comprises an access network query protocol (ANQP) element.

29. The apparatus of claim 19, wherein the first RAT comprises a wireless local area network (WLAN) and the second RAT comprises a cellular network.

30. A non-transitory computer-readable medium storing code for wireless communication, the code comprising instructions executable to:
receive, at a first access point, a discovery signal from a second access point, the second access point associated with a first radio access technology (RAT); and
determine, by the first access point, that the second access point is collocated with a cell of a second RAT based at least in part on the received discovery signal, the second RAT being different from the first RAT.
